(19) United States
(12) Patent Application Publication
(10) Pub. No.: US 2005/0044082 A1
(43) Pub. Date: Feb. 24, 2005

(54) Method, system and web service for delivering digital content to a user

(75) Inventors: Suresh Chande, Vantaa (FI); Markku Laitkorpi, Tampere (FI); Murali-Krishna Punaganti Venkata, Vantaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/883,645

(22) Filed: Jun. 30, 2004

(30) Foreign Application Priority Data
Jun. 30, 2003 (WO) PCT/IB03/02521

(51) Int. Cl. G06F 17/30

(52) U.S. Cl. 707/10

(57) ABSTRACT

The present invention relates to delivery of digital content of a content provider 110 to a user 160. The invention is based on the idea to utilize user presence information of a user in the delivery mechanism of digital content to the user. The operation of delivering digital content is separated in two co-operating services, a content service of a content provider 110 and a delivery service of a delivery provider 120. The content service utilizes the delivery service for accomplishing delivery of the digital content to a specific receiving user. Either the request to the delivery service to deliver the digital content, or the attempt by the delivery service to deliver the content, is made in dependence on user presence information indicating the availability of the user for receiving the digital content.

### TECHNICAL FIELD OF THE INVENTION

The present invention relates to a method, system and web service for delivering digital content of a content provider to a user.

### TECHNICAL BACKGROUND

In digital communications it is desirable to be able to deliver digital content to users connected to a digital communications infrastructure. A requirement in succeeding with the transmission of digital content to the user is that the user is connected to the specific communications infrastructure, i.e. that he is “on-line”. A request to deliver digital content to a user may come from the user himself, another user or from a third party service/server.

For example, within mobile telephony, it is becoming more and more popular to download personalized ringing tones to the mobile phones. Furthermore, a mobile user may want to provide a mobile phone of another user with a ringing tone or a music composition to be played once, for example a holiday greeting or a birthday or anniversary congratulation, or simply just for the fun of it. It is envisaged that also pictures or other kinds of digital content, such as various applications, soon will become as popular as ringing tones for download to mobile phones.

It is to be noted that the present invention by no means is restricted to the download or delivery of ringing tones and pictures to mobile phones, but that the invention relates to the delivery of any web content that is suitable for reception by a user with his choice of stationary or wireless terminal, and that the reception by means of a mobile phone merely is an exemplifying, interesting application of the present invention.

Today, when a content provider is to deliver digital content to a user, the content is typically sent immediately. The success of such delivery is dependent upon the timing of the delivery, i.e. that the user is available at the time, and upon the fact that the receiving user is willing to receive the content at that time. If the content provider does not receive an acknowledgement that the user has received the content, the content will have to be resent. This re-sending of the content may possibly have to be performed a number of times until an acknowledgement is received from the receiving user.

Thus, a problem with delivering digital content to a user is that a user may not be available, or willing, to receive the content at the time of the delivery attempt. As a consequence, the further problem arises that hardware and bandwidth resources often need to be repeatedly used for eventually accomplishing the delivery of the content to the user.

### SUMMARY OF THE INVENTION

An object of the present invention is to improve the performance of delivery of digital content to users normally able to receive such content.

According to a first aspect of the present invention, this object is achieved by a method for delivering digital content of a content provider to a user including the steps of receiving, at the content provider, a request to deliver specific digital content to the user; based on the receiving step, from a content service of the content provider, requesting a delivery service of a delivery provider to deliver the digital content to the user; and based on the requesting step, delivering the digital content to the user from the delivery service, wherein either the requesting step or the delivering step is performed when user presence information relating to the user indicates that the user is available for receiving the digital content.

According to a second aspect of the present invention, a system for delivering digital content of a content provider to a user, the system including a content provider server with a content service and a delivery provider server with a delivery service, wherein: the content provider server is configured for receiving a request to deliver specific digital content to the user; the content service is configured for requesting the delivery service to deliver the digital content to the user; and the delivery service is configured for delivering the digital content to the user, wherein either the requesting of the content service or the delivering of the delivery service is performed when user presence information indicates that the user is available for receiving the digital content.

The present invention is based on the idea to utilize user presence information of a user in the delivery mechanism of digital content to the user.

The invention is further based on the idea that the operation of delivering digital content to a user is separated in two co-operating services, a content service of a content provider and a delivery service of a delivery provider. The content service utilizes the delivery service for accomplishing delivery of the digital content to a specific receiving user. Either the request to the delivery service to deliver the digital content, or the attempt by the delivery service to deliver the content, is made in dependence on user presence information indicating the availability of the user for receiving the digital content.

This provides the advantage of being able to initiate delivery when the intended receiving user in fact is ready to receive the digital content, i.e. when he is connected to a communications infrastructure and is “on-line”. The probability of a successful delivery to the user is greatly increased. With knowledge of presence information of the user there will be no risk of attempting to transmit the digital content to the user when he is unable to receive it, and there will thus be no need for having to perform repeated delivery attempts. In this way, hardware and bandwidth resources associated with delivery of digital content will not be used unnecessarily, but only to actually deliver the digital content. Thus, the hardware implementing the delivery service, such as the central processing unit used for executing such service, and the bandwidth required for transmission of the digital content, will be used more economically.

Moreover, the separation of the operation to provide a user with digital content into a content service and a delivery service is advantageous since it introduces a high modularity and flexibility. It allows two different service brokers to be defined and to co-operate in accordance with certain set of rules that can be agreed upon. In this way a service broker may specialize and optimize either a content service or a delivery service in a similar way as parties specialize in and optimize such services outside of the digital world.

Basically, there can be two approaches for using user presence information in accordance with the invention.

According to one embodiment, user presence information is acquired by the content service before requesting the delivery service to deliver the digital content. In this way the content service will know that the user is available before requesting the delivery of the content.

According to another embodiment, user presence information is acquired by the delivery service after receiving the request for delivery of the content from the content service. In this way the delivery service will know that the user is available before attempting to actually deliver the content. Preferably, the delivery service waits for a time of delivery to occur before acquiring the user presence information. This time of delivery can either be a point of time specified in the original request to deliver the content to the user, or, as explained below, a point of time preferred by the receiving user.

Advantageously, before requesting user presence information of the user from a user presence service, a user profile/preference service is utilized for requesting the delivery preferences of the user, after which the requesting of user presence information of the user is made in dependence on the received delivery preferences of the user. This enables the acquirement of e.g. a user's preferred time of delivery of the digital content. It can also enable the acquirement of the user's preferred communication infrastructure. Thus, it allows the content service to request delivery of, or the delivery service to deliver, the digital content to the user at the user's preferred point of time and/or over the user's preferred communication path. Thus, the user will be provided with a more personalized delivery of the digital content.

The content provider either charges a party for a requested digital content delivery before requesting the delivery service to deliver the content, or for a performed delivery of the content after such delivery has been confirmed to the content provider by the delivery service. The concept of charging includes any state of the art method for accomplishing this, including any method based on the usage of credit points.

Thus, using the invention a content provider is able to provide a web service for delivery of digital content to various users and to charge a party requesting such delivery for the delivery and for the digital content itself.

The above mentioned and further features of, and advantages with, the present invention, will be more fully understood from the following description of a number of exemplifying embodiments of the invention. As is understood, various modifications, alterations and different combinations of features coming within the spirit and scope of the invention will become apparent to those skilled in the art when studying the general teaching set forth herein and the following detailed description.

### BRIEF DESCRIPTION OF THE DRAWINGS

Exemplifying embodiments of the present invention will now be described with reference to the accompanying drawings, in which:

FIG. 1 schematically shows an exemplified system and its overall operation in accordance with an embodiment of the invention;

FIG. 2 shows a sequence diagram with the schematic interactions between the elements in the system of FIG. 1 in accordance with an exemplifying embodiment of the invention;

FIG. 3 shows another sequence diagram with the schematic interactions between the elements in the system of FIG. 1 in accordance with another exemplifying embodiment of the invention; and

FIG. 4 shows yet another sequence diagram with the schematic interactions between the elements in the system of FIG. 1 in accordance with another exemplifying embodiment of the invention;

### DETAILED DESCRIPTION OF THE INVENTION

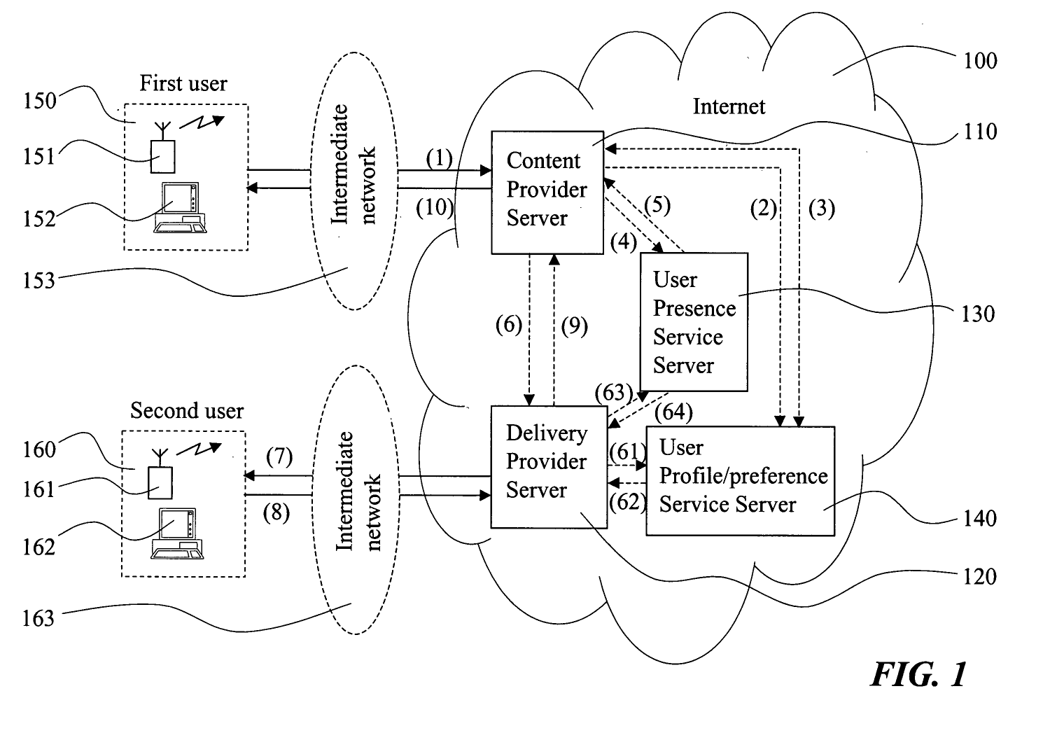

With reference to FIG. 1 an exemplifying embodiment of the invention will now be described. FIG. 1 shows a system for delivering digital content of a content provider to a user. The system includes a Content Provider Server 110 executing a content service, a Delivery Provider Server 120 executing a delivery service, a User Presence Service Server 130 and a User Profile/Preference Service Server 140, all of which servers are connected to the Internet 100. All of these servers are implemented with state of the art hardware known to the skilled person.

The operation of the content service of the Content Provider Server 110 and the delivery service of the Delivery Provider Server 120 is such that they in combination, and by utilizing the services provided by the User Presence Service Server 130 and the User Profile/Preference Service Server 140, provide a web service for delivering digital content of the Content Provider Server 110 to a user in accordance with the present invention. Thus, the Content Provider Server 110 and the Delivery Service Server 120 execute respective computer instructions that control the servers and their provided services to operate in accordance with the invention. This operation will later be described below. Even though the Content Provider Server 130 and the Delivery Provider Server 120 are depicted as different entities in FIG. 1, the skilled person will realize that these servers in fact can be implemented with one and the same hardware, while still separating the content service and the delivery service.

The User Presence Service Server 130 is a state of the art server providing state of the art services. Thus, its basic operation and functioning should be well known to the skilled person. Typically, the User Presence Service Server 130 manages user presence information relating to different users. This includes receiving updates regarding the presence information of specific users, servicing requests for presence information relating to specific users and servicing subscriptions to receive presence information relating to specific users. By subscribing to user presence information for a specific user, a subscribing application is notified by the service when there is a change of the presence information for that user, e.g. if the user goes “on-line” or “off-line”.

Advantageously the User Presence Service Server 130 is implemented as a SIP (Session Initiation Protocol) server, i.e. a server using the SIP protocol for signaling communication. The SIP protocol and the possibilities it provides are known to the skilled person. Of course, a SIP presence server 130 implies that the services/applications and terminals utilizing the services provided by the SIP presence server 130 will include SIP clients able to perform signaling communication by means of the SIP protocol.

The User Profile/Preference Service Server 140 manages the profiles/preferences for respective users. A user may store his profile/preference at the server for later retrieval by an application or another user. The profile/preference may include various kind of information, e.g. the user's preferred network, available bandwidth, terminal type/class etc.

FIG. 1 also includes a first user 150 and a second user 160. Both first and second user have means for connecting to the Internet, e.g. a wireless terminal 151, 161 or a stationary computer 152, 162. Typically the users connect to the Internet via some kind of intermediate network 153, 163. If the user has a wireless terminal, such as a mobile telephone or a PDA (Personal Digital Assistant) or laptop with associated radio transceiver circuitry, the intermediate network is a radio communications network, e.g. a GSM-network (Global System for Mobile communications). If the user uses a stationary computer the intermediate network can be the PSTN (Public Switched Telephone Network) or some other fixed network.

Still referring to FIG. 1, various exemplifying modes of operation in accordance with embodiments of the invention will now be described. In these exemplifying embodiments it is the first user that requests delivery of digital content to the second user. It is to be noted that even though a first user 150 is depicted in FIG. 1 as the one requesting the delivery of the digital content, this request may be received by the Content Provider Server 110 from any party wishing to deliver digital content to the second user 160. Thus, such a request may also originate from an application on another server or from the receiving user himself, i.e. from the second user 160.

The operation starts with an event such that the Content Provider Server 110 receives (1) a request from the first user 150 to deliver a specific digital content to a specific user, in this case to the second user 160. The content service of the Content Provider Server 110 then requests (2) the preferences of the second user 160 from the User Profile/Preference Service Server 140. In response thereto, the content service will receive (3) the second user's 160 profile/preferences, for example a preferred time of reception.

The content service will then in dependence on the response (3) received on account of the profile/preferences request (2), request (4) user presence information of the second user 160 from the User Presence Service Server 130. For example, if the received profile/preferences included a preferred time of reception for the user 160, the content service will wait for that point of time to occur before requesting (4) the user presence information. However, this waiting could also be a consequence of the fact that the initial request received by the content service to deliver a specific digital content included an indication from the requesting party of a certain time of delivery for the digital content. If the User Presence Service Server 130 responds (5) with information that the user 160 is not available, the content service 110 can request a subscription for user presence information relating to user 160, and eventually the user presence service 130 will then notify (5) the content service 110 that the second user 160 is available, or “on-line”.

When the content service 110 is informed that the second user 160 to which the digital content is to be transmitted is available, it requests (6) a delivery service on the Delivery Provider Server 120 to deliver the digital content to the second user 160. In response thereto the delivery service delivers (7) the digital content to the second user 160.

If the second user is configured to acknowledge (8) reception of the digital content back to the delivery service, the delivery service may notify (9) the content service of the successful delivery. The content service may then charge (10) the party that initially requested delivery of the digital content for the services performed. Alternatively, this step of charging the requesting party could be performed in advance of the performance of the service and based on what services that are requested by this party.

The steps (2)-(5) are indicated with dashed arrows since they, as an alternative to being initiated by the content service, instead may be initiated by the delivery service. Thus, when initiated by the delivery service it is the steps (61)-(64), also indicated with dashed arrows, that are present in the operation rather than the steps (2)-(5). In either case, the User Profile/Preference Service Server will be requested, step (2) or (61), for the profile/preference of the user and then respond, step (3) or (62), with that profile/preference. Based on the received profile/preference, the User Presence Service/Server will be requested, step (4) or (63) for user presence information and respond, step (5) or (64), with such information.

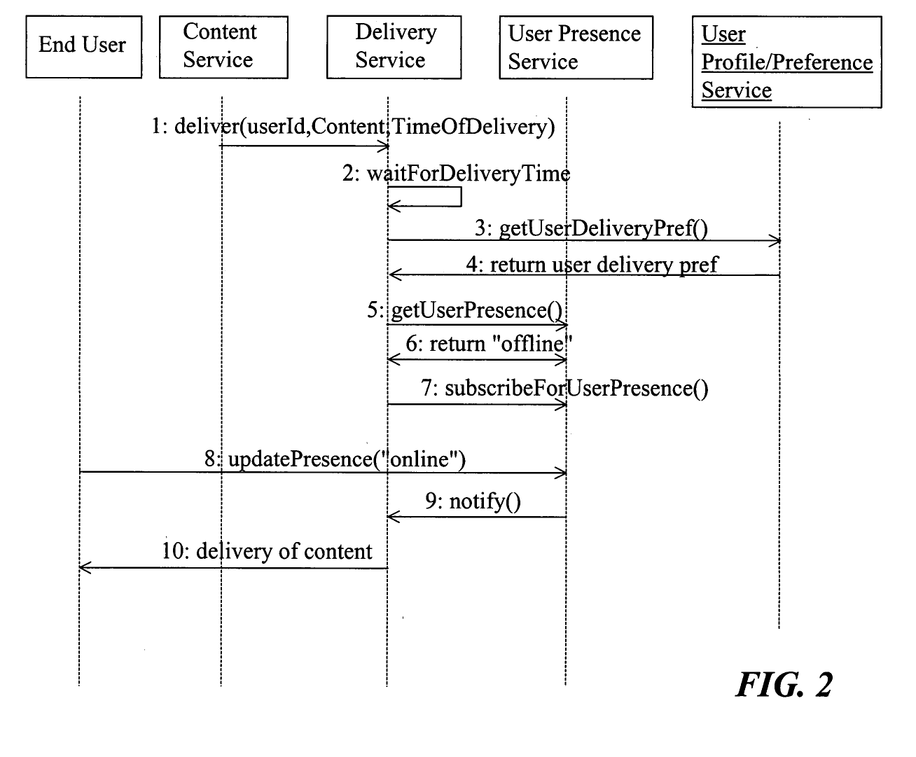

FIG. 2 shows the interaction between the elements in the network of FIG. 1 in accordance with an embodiment of the invention. With reference to the signaling flow shown in FIG. 2, the process involving the elements of FIG. 1 is as follows (wherein the numbering differs from that used in FIG. 1):

1. The Content Provider Server has been requested to transfer some specific digital content to a specific user at a certain time of delivery. The content service requests a delivery service to deliver the specific digital content (identified by the parameter Content) to the specific user (identified by the parameter userId) at the requested time of delivery (identified by the parameter TimeOfDelivery).

2. Upon receiving the request the delivery service waits until present time corresponds to the requested time of delivery.

3. When it is time to deliver the digital content, or possibly slightly in advance, the delivery service requests the user's profile/preference by transmitting a message getUserDeliveryPref( ) to the user profile/preference service.

4. In response to the profile/preference request, the user profile/preference service will return the user's delivery preferences.

5. The delivery service now requests user presence information from the user presence service by transmitting a message getUserPresence( ) to the user presence service.

6. In this particular case, the user is currently “off-line” and a message indicating that is returned to the delivery service.

7. The delivery service then decides to subscribe to user presence information relating to the user by transmitting a message subscribeForUserPresence( ) to the user presence service.

8. The user then comes “on-line” and therefore updates his presence by transmitting a message updatePresence (“online”) to the user presence services.

9. In response to the user's updated presence, the user presence service notifies the subscribing delivery service of the user's updated presence.

10. The delivery service now knows that the user is available and therefore delivers the digital content to the user.

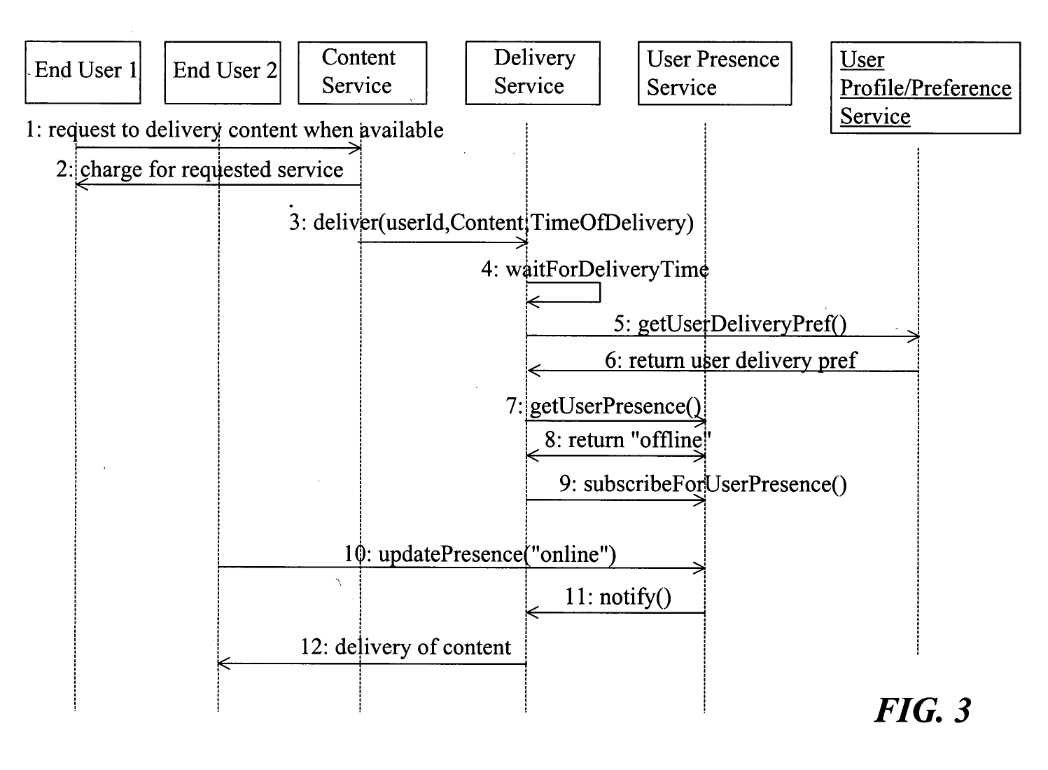

FIG. 3 shows the interaction between the elements in the network of FIG. 1 in accordance with another embodiment of the invention. With reference to the signaling flow shown in FIG. 3, the process involving the elements of FIG. 1 is as follows:

1. The first end user 150 selects a specific digital content to be delivered to the second user 160 by requesting the content service to deliver that specific digital content to the second user.

2. The content service then charges the first end user for the requested service.

The sequence 3-12 that follows correspond to the sequence 1-10 in FIG. 2 and will thus not be repeated here. The sequence diagram shows that digital content finally is delivered to the second end user 160.

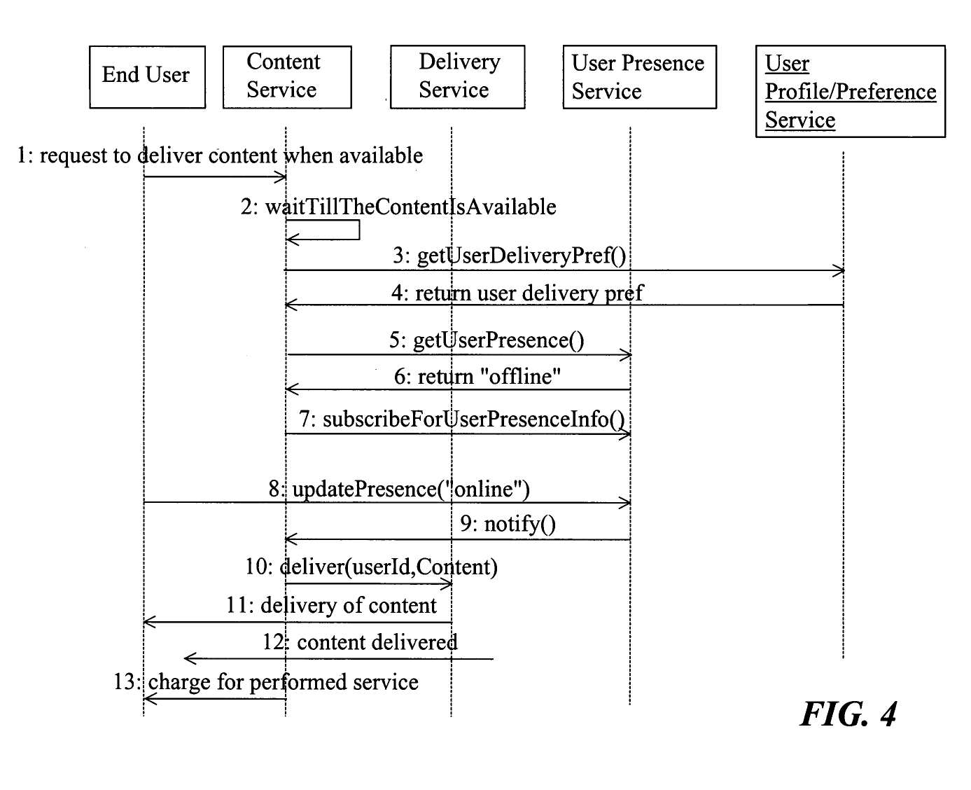

FIG. 4 shows the interaction between the elements in the network of FIG. 1 in accordance with yet another embodiment of the invention. With reference to the signaling flow shown in FIG. 4, the process involving the elements of FIG. 1 is as follows:

1. An end user, e.g. the second user 160 in FIG. 1, requests the Content Provider Server to deliver some digital content to him when the content becomes available. For example, a digital content that perhaps not yet has been produced, such as a future weather forecast or a not yet released audio or video composition etc.

2. The content service waits until the content finally is available, e.g. due to that it is electronically published.

3. When the content is available, the content service requests the user's profile/preference by transmitting a message getUserDeliveryPref( ) to the user profile/preference service.

4. In response to the profile/preference request, the user profile/preference service will return the user's delivery preferences.

5. The content service now requests user presence information from the user presence service by transmitting a message getUserPresence( ) to the user presence service.

6. In this particular case, the user is currently “off-line” and a message indicating this is returned to the delivery service.

7. The content service then decides to subscribe to user presence information relating to the user by transmitting a message subscribeForUserPresenceInfo( ) to the user presence service.

8. The user then comes “on-line” and therefore updates his presence by transmitting a message updatePresence (“online”) to the user presence services.

9. In response to the user's updated presence, the user presence service notifies the subscribing content service of the user's updated presence.

10. The content service now knows that the user is available and therefore requests the delivery service to deliver the specific digital content (identified by the parameter Content) to the specific user (identified by the parameter userId).

11. The delivery service delivers the requested content to the user.

12. The delivery service notifies the content service that the content has been delivered.

13. The content service charges the party that requested the delivery, in this case the user to which the content was delivered, for the services performed.

It should be noted that the detailed description above of different embodiments of the invention has been given by way of illustration only, and that various alterations and modifications falling within the scope of the appended claims and within the spirit and scope of the general teaching set forth herein will become apparent to those skilled in the art.

1. A method for delivering digital content of a content provider to a user, including the steps of:
receiving, at the content provider, a request to deliver specific digital content to the user;
based on the receiving step, from a content service of the content provider, requesting a delivery service of a delivery provider to deliver the digital content to the user; and
based on the requesting step, delivering the digital content to the user from the delivery service, wherein either the requesting step or the delivering step is performed when user presence information relating to the user indicates that the user is available for receiving the digital content.

2. The method as claimed in claim 1, wherein the user presence information is acquired by the content service, before requesting the delivery service to deliver the digital content, by performing the steps of:
requesting user presence information of the user from a user presence service; and
receiving user presence information of the user in response thereto.

3. The method as claimed in claim 2, wherein the step of the content service to request user presence information of the user from the user presence service is preceded by the step of:
waiting until the content to be delivered is available.

4. The method as claimed in claim 1, wherein the user presence information is acquired by the delivery service, after receiving the request for delivery from the content service, by performing the steps of:
requesting user presence information of the user from a user presence service; and
receiving user presence information of the user in response thereto.

5. The method as claimed in claim 4, wherein the step of the delivery service to request user presence information of the user from the user presence service is preceded by the step of:
waiting for a time of delivery as specified in the request received by the content provider to deliver the digital content to the user.

6. The method as claimed in claim 2, wherein the step of requesting the presence information of the user includes:
requesting a subscription for the user presence information of the user at the user presence service.

7. The method as claimed in claim 2, wherein the step of requesting user presence information of the user from the user presence service is preceded by the steps of:
requesting a user profile/preference service for the delivery preferences of the user; and
receiving the delivery preferences of the user in response thereto,
wherein the step of requesting presence information of the user is made in dependence on the received delivery preferences of the user.

8. The method as claimed in claim 7, wherein the delivery preferences of the user include a preferred time of delivery or a preferred communication path for the delivery.

9. The method as claimed in claim 1, wherein the content provider, in response to the received request to deliver the digital content, before requesting the delivery service to deliver the digital content, performs the step of:
charging a party that requested the delivery of the digital content for the services requested.

10. The method as claimed in claim 1, wherein the content provider, in response to a notification from the delivery service that the digital content has been delivered to the user, performs the step of:
charging a party that requested the delivery of the digital content for the services performed.

11. The method as claimed in claim 1, wherein the user presence information relates to the user's presence in a radio communications network by way of a connected mobile communication terminal.

12. A web service for delivering digital content of a content provider to a user and designed to perform the steps recited in claim 1.

13. A system for delivering digital content of a content provider to a user, the system including a content provider server with a content service and a delivery provider server with a delivery service, wherein:
the content provider server is configured for receiving a request to deliver specific digital content to the user;
the content service is configured for requesting the delivery service to deliver the digital content to the user; and
the delivery service is configured for delivering the digital content to the user,
wherein either the requesting of the content service or the delivering of the delivery service is performed when user presence information indicates that the user is available for receiving the digital content.

14. The system as claimed in claim 13, wherein the content service is configured to acquire user presence information before requesting the delivery service to deliver the digital content, by being configured for:
requesting user presence information of the user from a user presence service; and
receiving user presence information of the user in response thereto.

15. The system as claimed in claim 14, wherein the content service, before requesting user presence information of the user from the user presence service, is configured for:
waiting until the content to be delivered is available.

16. The system as claimed in claim 13, wherein the delivery service is configured to acquire user presence information after receiving the request for delivery from the content service, by being configured for:
requesting user presence information of the user from a presence service; and
receiving user presence information of the user in response thereto.

17. The system as claimed in claim 16, wherein the delivery service, before requesting user presence information of the user from the user presence service, is configured for:
waiting for a time of delivery as specified in the request received by the content provider to deliver the digital content to the user.

18. The system as claimed in claim 14, wherein the requesting of user presence information of the user includes:
requesting a subscription for the user presence information of the user at the user presence service.

19. The system as claimed in claim 14, wherein the content service or the delivery service, before requesting user presence information of the user from the user presence service, is configured for:
requesting a user profile/preference service for the delivery preferences of the user; and
receiving the delivery preferences of the user in response thereto,
wherein the requesting of user presence information of the user is made in dependence on the received delivery preferences of the user.

20. The system as claimed in claim 19, wherein the delivery preferences of the user include a preferred time of delivery or a preferred communication path for the delivery.

21. The system as claimed in claim 13, wherein content provider server, in response to the received request to deliver the digital content, before requesting the delivery service to deliver the digital content, is configured for:
charging a party that requested the delivery of the digital content for the services requested.

22. The system as claimed in claim 13, wherein content provider server, in response to a notification from the delivery service that the digital content has been delivered to the user, is configured for:
charging a party that requested the delivery of the digital content for the services performed.

23. The system as claimed in claim 13, wherein the user presence information relates to the user's presence in a radio communications network by way of a connected mobile communication terminal.
